(19) United States
(12) Patent Application Publication
(10) Pub. No.: US 2006/0067781 A1
(43) Pub. Date: Mar. 30, 2006

(54) Package with applicator for dispensing liquid or viscous products

(75) Inventors: Teofilo M. Pleil, Torrington, CT (US); Dianne Collins, Torrington, CT (US); David Ineson, Oakville, CT (US); Steven Kahn, Torrington, CT (US); Kristin LaFond, Torrington, CT (US); Robert Pierpont, Meriden, CT (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Rexam Cosmetic Packaging, Inc.

(21) Appl. No.: 10/954,794

(22) Filed: Sep. 30, 2004

(51) Int. Cl. B43K 5/16

(52) U.S. Cl. 401/116

(57) ABSTRACT

A unitary package having a retractable applicator is particularly suited for dispensing liquid or semi-liquid cosmetic products, such as lip gloss or mascara. The package has a main body and a tubular shell arranged concentrically, wherein the tubular shell has a first portion disposed externally of the main body and a second portion disposed internally of the main body. The outer surface of the tubular shell is adapted to be grasped and rotated with respect to the main body. The inside of the main body defines a reservoir, and the applicator is positioned within and movable with respect to the reservoir. The portion of the tubular shell internal to the main body is threaded and cooperates with threads on the applicator to cause the applicator to extend from within the reservoir to a position external of the package.

### BACKGROUND OF THE INVENTION

The invention relates to an apparatus useful for dispensing liquid or viscous products. More particularly, the invention relates to a package useful in the dispensing of a liquid or viscous cosmetic product.

Liquid or semi-liquid cosmetic products, such as lip gloss or mascara, are often contained and dispensed from packages using a brush or foam tip applicator. Typically, a package used for dispensing the cosmetic product comprises two segments, a first segment that contains a reservoir of cosmetic material and a second segment that comprises an applicator such as a brush. In use, the two-part cosmetic package has several drawbacks. For instance, the applicator section and the reservoir section of the traditional package are fixed together, with the applicator inside the reservoir, when the applicator is not in use. Further, because the package is two parts, it requires the use of both hands when applying cosmetics.

Some present-day cosmetic packages are unitary packages that contain an internal cosmetic reservoir. A movable applicator is disposed within the package and may be moved by the user from a retracted position, where the applicator receives cosmetic from the internal reservoir, to an extended position, where the applicator projects through an opening in the package, so that cosmetic may be applied from the applicator to the user.

The unitary packages are more convenient for the user than the dual section packages, but the unitary packages of the past still suffer from drawbacks. The unitary packages usually contain somewhat complex mechanical components needed to move the applicator with respect to the reservoir in response to manipulation of the package by the user. For instance, applicators may be attached to the package by threaded or spring-loaded mechanisms. Since those mechanisms are often mass produced and poorly engineered, those mechanisms are subject to failure and breakage during use. Further, many unitary packages are not ergonomically designed and are not easily manipulated by the user.

It is desired to provide an improved unitary cosmetic package with mechanical functionality that promotes reliability and longevity of the package. It is further desired to provide an improved cosmetic package with improved ergonomics such that the package is easily manipulated by a user.

### BRIEF SUMMARY OF THE INVENTION

The invention is a package for dispensing a liquid or viscous product. The package comprises a tubular main body and a concentrically arranged tubular shell. The main body has upper and lower ends and a hollow interior defining a reservoir for the product. An axial opening is formed at the upper end of the main body. The tubular shell has an outer first portion disposed externally of the main body and an inner second portion disposed internally of the main body. The outer portion of the tubular shell overlaps the outer surface of the main body and is adapted to be grasped and rotated with respect to the main body.

An applicator is mounted for axial movement within the main body between a retracted position and an extended position. The applicator has an applicator tip that is positioned within the reservoir when the applicator is in the retracted position and projects from the axial opening in the main body for application of the product when the applicator is in the extended position. An advance interface cooperates with the applicator and with the tubular shell for moving the applicator axially between the retracted and extended position in response to rotation of the shell with respect to the main body.

Structural advantages are gained over previous packages by having at least part of the outer tubular shell in contact with the main body. The main body supports the tubular shell such that, when rotational force is applied by a user, the tubular shell is kept in axial alignment with the main body and applicator so that the package mechanism works smoothly. Also, operation is simplified by having the tubular shell communicate force from the user directly to the applicator without the need for intermediate parts. The tubular shell may extend along a substantial portion of the outer surface of the main body, thus providing the user with a large gripping surface for use in operating the package. The package thus has several ergonomically desirable features.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view of the cosmetic package according to one embodiment of the invention;

FIG. 2 is a cross-sectional view of the cosmetic package shown in FIG. 1;

FIG. 3 is a perspective view of the cosmetic package according to another embodiment of the invention;

FIG. 4 is a cross-sectional view of the cosmetic package shown in FIG. 3;

FIG. 5 is a cross-sectional view of a cap for use with the package; and,

FIG. 6 is a cross-sectional view of yet another embodiment of the invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

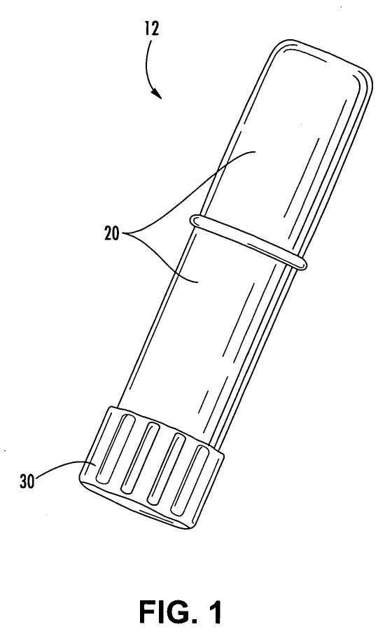

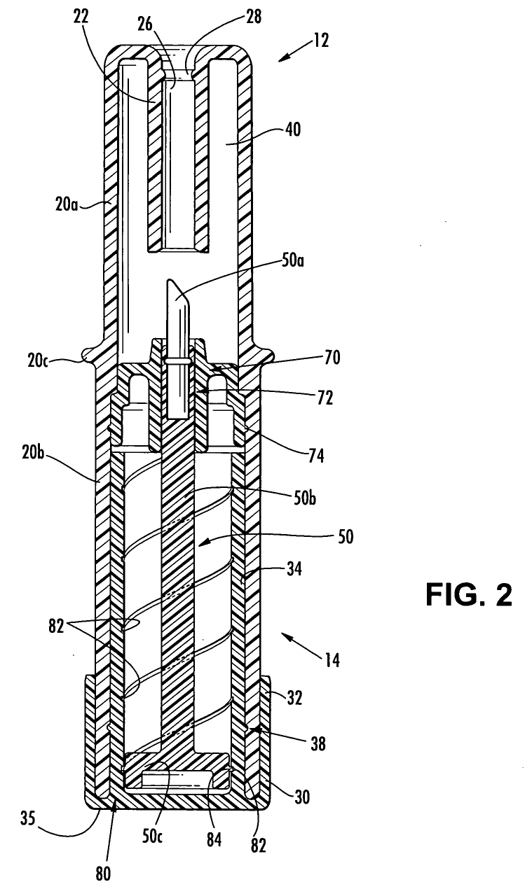

A cosmetic package in accordance with one embodiment of the present invention, as shown in FIGS. 1 and 2, has a tubular shape with an upper end 12 and opposing lower end 14. The package includes a tubular hollow main body 20 and a tubular shell 30. The main body 20 includes an upper cylindrical portion 20a and a lower cylindrical portion 20b with a flange 20c therebetween. In the embodiment shown, the main body comprises a single unitary piece of material, although the upper and lower cylindrical portions 20a, 20b could be formed as separate pieces that are fixedly attached at flange 20c to form a fluid-tight seal.

The tubular shell 30 is mounted for rotation relative to the main body 20, but is axially fixed with respect to the main body 20. The tubular shell 30 includes an outer portion 32 in the form of a cylindrical wall disposed externally of the main body 20 and adapted to be grasped and rotated, and an inner portion 34 disposed internally of the tubular main body 20.

At the top of the main body 20, the side walls of the upper cylindrical portion 20a turn inward to define an axial opening 26, and an integral cylindrical wall 22 extends axially inwardly into the interior of the upper cylindrical portion 20a to form an elongate axially extending passageway concentric with the side walls of the upper cylindrical portion 20a. A reservoir 40 for containing cosmetic material is thus defined within the main body 20 by the cylindrical side walls of the upper cylindrical portion 20a and the inwardly extending cylindrical wall 22 and by a liquid-tight seal 70 disposed within the main body 20.

An applicator 50 is provided within the package having an applicator tip 50a that can be moved axially outwardly as described more fully below from a retracted storage position within the reservoir 40 as shown in FIG. 2, through the elongate passageway defined by the cylindrical wall 22, and to an axially extended position in which the applicator tip 50a projects from the upper end of the package.

Referring to the lower end of the package 14, the bottom of the lower cylindrical portion 20b is open-ended to facilitate connection of the main body with the tubular shell 30, which is connected to the main body 20 at the bottom of the lower cylindrical portion 20b. The tubular shell 30 is mounted for rotation relative to the main body 20, but is axially fixed with respect to the main body 20. The tubular shell 30 includes an outer portion 32 in the form of a cylindrical wall disposed externally of the main body 20 and adapted to be grasped and rotated, and an inner portion 34 disposed internally of the main body 20. As used with regard to the relationship of the tubular shell and main body, “external” means overlapping at least a region of the outer surface of the cylindrical main body 20 while “internal” means adjacent to the inner surface of the cylindrical main body 20. At least a portion of the external tubular shell 30 is in flush contact with the outer surface of the lower end 14 of the main body. The outer diameter of the inner tubular shell portion 32 preferably rests flush against the internal diameter of the main body 20. The inner portion 34, more particularly, is cylindrical and has an outside diameter corresponding to the inside diameter of the lower portion 20b of the tubular main body so that the inner portion 34 can be received within the lower portion 20b. The outer portion 32 and the inner portion 34 are joined to a solid bottom 35 of the shell 30 and are spaced apart from one another to provide an annular recess for receiving the lowermost part of the lower portion 20b of the main body.

The main body 20 and tubular shell 30 may be connected in a suitable manner allowing the two parts to be concentrically arranged and rotatably connected to one another. An example of such a connection is the snap-fit ridge and groove arrangement 38 shown in FIG. 2, where a ridge on one part, e.g. the inner portion 34 as shown, and a corresponding the groove on the other part, e.g. the outer portion, allow rotation of the connected elements but retain the parts in assembled relationship, preventing axial movement with respect to each other.

The applicator 50 is mounted for axial movement within the main body 20 so that the applicator 50 may be moved between a retracted position and an extended position. The applicator 50 comprises an applicator tip 50a, an elongate axially extending shank 50b of a non-circular cross-section, and a base member 50c. The applicator tip 50a is typically a pliable material capable of absorbing cosmetic material, such as a foam, sponge, fabric, or brush. The applicator shank 50b is connected at its upper end to the applicator tip 50a and at its lower end to the base member 50c. The base member 50c has an enlarged configuration so that at least a portion of its outer peripheral surface engages the internal surface of the inner portion 34 of the tubular shell. A helical advance interface 80 is provided at this location to convert a rotational movement of the outer portion 32 of the shell into an axial movement of the applicator 50. As shown, the inner surface of the inner tubular shell 34 is inscribed with at least one helical thread or channel 82. The base member 50c of the applicator 50 terminates radially into at least one lug 84 which is received by a correspondingly located thread or channel 82. Thus, rotation of the tubular shell with respect to the applicator translates into axial movement of the applicator 50. It is preferred that two or more lugs be spaced apart from one another about the base member 50c and further preferred that the periphery of the base member 50c immediately adjacent each lug 84 mate flush with the internal surface of the inner tubular shell 34 so that the applicator body 50b is stabilized radially during operation of the package.

A liquid-tight seal 70 is fixed within the main body 20 separating the reservoir 40 from the internal volume of the lower end 14 of the main body. An aperture 72 is formed in the seal 70 and extends axially therethrough. The aperture 72 has a non-circular geometric cross-section that corresponds to the non-circular cross-section of the applicator shank 50b and thereby prevents product present in the reservoir 40 from passing through the aperture 72. The applicator shank 50b can move axially through the aperture 72 but because of the non-circular cross-section of the shank 50b, it does not rotate. Exemplary geometries include oval or square. The seal 70 may be secured in place within the main body 20 by any suitable arrangement. In the embodiment shown, the dimensional tolerances provide for a snap fit, and lugs and corresponding recesses, indicated at 74, on the outer periphery of the seal 70 and the inner surface of the body 20, hold the seal 70 securely in place.

In the retracted storage position shown in FIG. 2, the applicator rests in a retracted position such that the tip 50a of the applicator resides within the reservoir 40 where it absorbs or is coated by cosmetic product. Rotation of the tubular shell 30 with respect to the main body 20 causes an upward force to be exerted upon the applicator 50 by the interface 80. The applicator 50 is restricted from rotation by the non-circular seal aperture 72 and is thus propelled axially upward through the aperture 72 in seal 70. Upon continued rotation of the tubular shell, the applicator tip 50a projects through the axial opening 26 of the main body so that the product upon the applicator tip 50a may be applied by the user. A wiper 28 is provided within the axial opening 26 to remove excess product from the applicator tip as it is extended out of the product reservoir 40. Because the passageway defined by the cylindrical wall 22 is relatively narrow, the viscous cosmetic product does not flow freely and is thus prevented from escaping from the reservoir 40. The wiper 28 can be a separate component made of an elastomer with bore slightly smaller than the diameter of the flexible applicator tip. The wiper 28 may be part of the axial opening or may be adjacent the axial opening but integrated into the product reservoir. To store the applicator, rotation of the tubular shell is reversed and the applicator is retracted within the package.

As mentioned, the tubular shell 30 of this embodiment has an outer portion 32 that resides radially outside and an inner portion 34 that resides radially inside of the lower portion 20b of the main body. The outer portion 32 of the shell 30 rests flush against but is not fixedly bonded to the outer surface of the lower body 20b. The cross-sections of both the lower body 20b and the outer tubular shell 32 are such that the lower body 20b and outer tubular shell 32 may be rotated with respect to one another while maintaining a flush correspondence. The inner tubular shell 34 preferably rests flush against the inside surface of the lower body 20b.

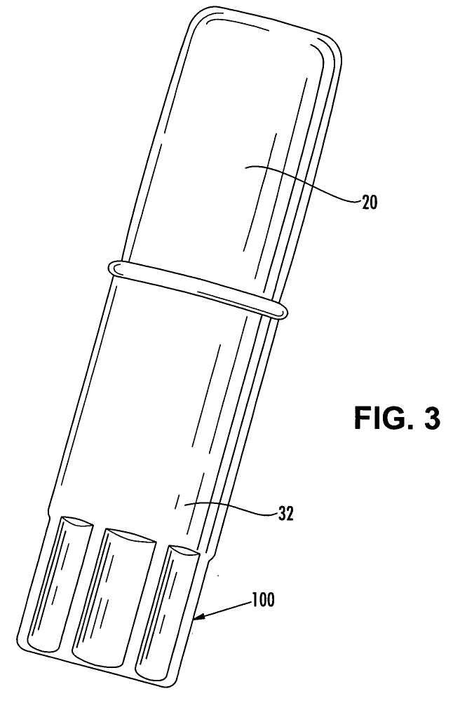

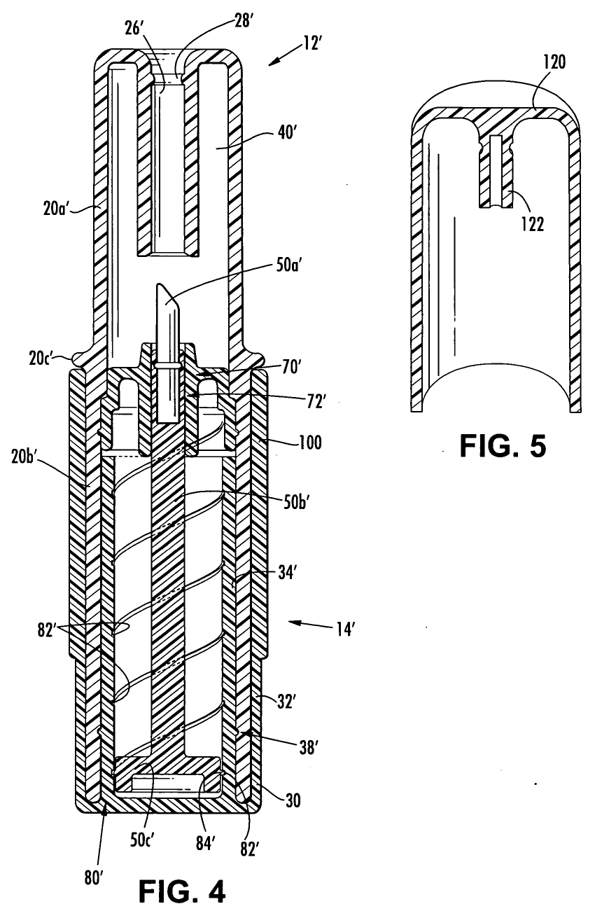

FIGS. 3 and 4 illustrate an alternate embodiment which is similar in many respects to the embodiment previously described in connection with FIGS. 1 and 2. To avoid repetitive description, elements in this embodiment that correspond to elements of the embodiment of FIGS. 1 and 2 have been identified with corresponding reference numbers with prime (′) notation added. In this embodiment, the outer shell portion 32′ extends along a substantial portion of the outer surface of the lower main body 20b′. The longer extent of the outer shell portion 32′ provides a larger surface for the user to hold when using the package. The outer surface of the outer shell portion 32′ may be provided with a gripping surface 100, such as an outer geometry having an unsmooth surface that enables the user to better grip and rotate the tubular shell 30′ of the package.

Referring to FIG. 5, the package may be provided with a removable cap 120. The cap 120 is shaped to correspond with the shape of the upper region of the upper main body 20a and forms a seal with the upper main body 20a when installed. The cap 120 preferably has a stem 122 projecting from the inner surface of the cap, where the stem corresponds to the shape of the opening 26 or, alternatively to the wiper 28 if the wiper 28 is installed within the opening 26. The stem 122 seals the opening 26 when the cap is installed. The cap may be snap-fit, friction-fit, threaded, or otherwise connectable in an air-tight manner.

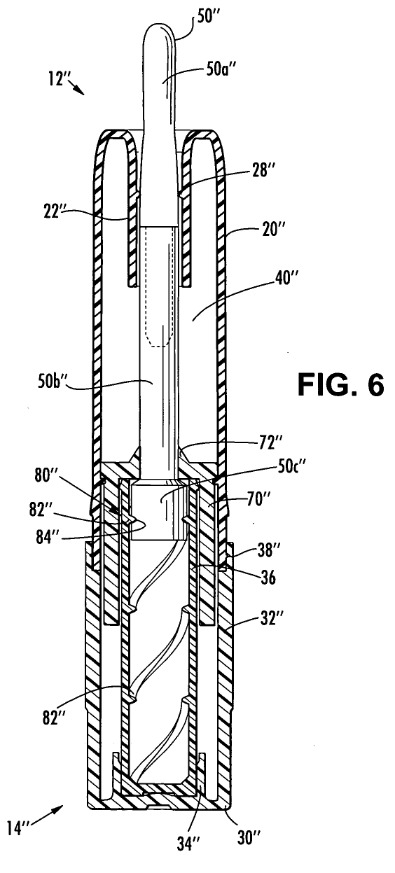

According to the embodiments above, the tubular shell 30′ is a unitary component. Referring to FIG. 6, an embodiment of the invention is shown in which the tubular shell 30″ is still a unitary component but comprises an external portion 32, internal portion 34, and a separate threaded component 36 that may be attached to the internal portion 34 of the tubular shell during assembly so that a tubular component with inwardly extending threads 82″ is fixedly attached to the internal portion 34 of the shell and threadably engaged with the base member 50c″ of the applicator. The combined components of the tubular shell 32, 34, 36 of this embodiment perform as the unitary tubular shells of previous embodiments, but this embodiment demonstrates that the tubular shell may be assembled from various physical parts, i.e. 32, 34 and 36, that are fixed to one another. The use of multiple parts provides flexibility in assembling the tubular shell. For instance, during assembly, the threaded component 36 may be threaded onto the applicator shank 50b″ within the main body 20″, after which the remaining portion of the tubular shell 32, 34 may be snap-fit or otherwise fixedly attached to the threaded component 36 in order to form a unitary tubular shell 30″.

Further according to the embodiment of FIG. 6, the outer periphery of the seal 70″ projects downwards to form a cylindrical collar between the main body 20″ and the threaded component 36. The threaded component 36 is held steadily in axial alignment during rotation by flushly mating the outer surface of the aforementioned collar with the inner surface of the main body 20″, and further by flushly mating the inner surface of the collar with the outer surface of the threaded component 36.

The helical advance interface 80″ of the embodiment of FIG. 6 comprises male threads 82″ extending from the inner surface of the threaded component 36 that mate with corresponding female indentations 84″ on the outer surface of the base member 50c″. As with previous embodiments, rotation of the tubular shell 32″ with respect to the base member 50c″ causes the applicator 50″ to extend or retract, depending upon the direction of rotation.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A package for dispensing a liquid or viscous product, said package comprising:
a tubular main body having upper and lower ends and a hollow interior defining a reservoir for the product and having an axial opening formed at said upper end,
a tubular shell connected to said main body and mounted for rotation relative thereto, said tubular shell including an outer portion disposed externally of the main body and adapted to be grasped and rotated and an inner portion disposed internally of the main body,
an applicator mounted for axial movement within the main body between a retracted position and an extended position, the applicator having an applicator tip that is positioned within the reservoir when the applicator is in the retracted position and projects from said opening for application of the product when the applicator is in the extended position, and
an advance interface cooperating with the applicator and with the tubular shell for moving the applicator axially between the retracted and extended positions in response to rotation of the shell with respect to the main body.

2. The package of claim 1, wherein the lower end of the main body is cylindrical and the tubular shell is concentrically arranged with the lower end of the main body.

3. The package of claim 1, wherein the inner portion of the tubular shell is received by the lower end of the tubular main body, and wherein the external portion of the tubular shell overlies a portion of the outer surface of the main body.

4. The package of claim 1, wherein the applicator comprises a tip, a shank, and a base member.

5. The package of claim 4, wherein the applicator tip is a foam, sponge, fabric, or brush.

6. The package of claim 4, wherein the advance interface includes helical threads disposed upon the inner portion of the tubular shell in cooperation with lugs extending from the base member.

7. The package of claim 4, wherein the tubular main body has an upper cylindrical portion including cylindrical side walls, a top wall containing said axial opening, and an integral cylindrical wall extending axially into the interior of the upper cylindrical portion to form an elongate axially extending passageway communicating with the axial opening and arranged for receiving the applicator tip when it is moved axially to the extended position.

8. The package of claim 4, further comprising a seal fixed within the main body at a position below the reservoir, separating the reservoir from the inside of the lower end of the main body, wherein the seal defines a non-circular aperture through which the applicator can move axially but can not rotate with respect to the aperture.

9. The package of claim 1, wherein the reservoir contains cosmetic product.

10. The package of claim 1, further comprising a cap shaped to correspond with the shape of the upper main body.

11. A package for dispensing a liquid or viscous product, said package comprising:
a tubular main body having an axial opening at its upper end;
a seal disposed within said main body that divides an upper portion of the main body from a lower portion of the main body,
an axial aperture formed in the seal and providing communication between the upper and lower portions of the main body;
an applicator positioned within said main body, with a portion of the applicator extending axially through said aperture;
a tubular shell connected to said main body and mounted for rotation relative thereto, said tubular shell including an outer portion disposed externally of the main body and adapted to be grasped and rotated and an inner portion disposed internally of the main body, wherein said inner portion cooperates with the applicator for moving the applicator axially between a retracted and an extended position in response to rotation of the shell with respect to the main body.

12. The package of claim 11, wherein the tubular shell is concentrically arranged with the lower end of the main body.

13. The package of claim 11, wherein the applicator includes a tip positioned in the upper portion of the main body, a base member positioned in the lower portion of the main body, and a shank extending axially through the aperture and connected to said tip and to said base member.

14. The package of claim 13, wherein the applicator tip is a foam, sponge, fabric, or brush.

15. The package of claim 13, further comprising a seal fixed within the main body at a position below the reservoir separating the reservoir from the inside of the lower end of the main body, wherein the seal defines a non-circular aperture through which the applicator shank can move axially but can not rotate with respect to the aperture.

16. The package of claim 11, wherein the upper portion of the main body forms a reservoir.

17. The package of claim 16, wherein the reservoir contains cosmetic product.

18. The package of claim 11, further comprising a cap shaped to correspond with the shape of the upper main body.

19. A package for dispensing a liquid or viscous product, said package comprising:
a tubular main body having upper and lower ends, a hollow interior defining a reservoir, and an axial opening formed at said upper end,
a tubular shell connected to said main body and mounted for rotation relative thereto, said tubular shell including an outer portion disposed externally of the main body and adapted to be grasped and rotated, an inner portion disposed internally of the main body, and a threaded component also disposed internally of the main body and fixedly connected to the inner portion, and
an applicator mounted for axial movement within the main body between a retracted position and an extended position, the applicator having an applicator tip that is positioned within the reservoir when the applicator is in the retracted position and projects from said opening for application of the product when the applicator is in the extended position,
wherein the threaded component of the tubular shell cooperates with the applicator for moving the applicator axially between the retracted and extended positions in response to rotation of the shell with respect to the main body.

20. The package of claim 19, wherein the lower end of the main body is cylindrical and the tubular shell is concentrically arranged with the lower end of the main body.

21. The package of claim 20, wherein the external portion of the tubular shell overlaps the outer surface of the main body and at least a region of the external portion of the tubular shell is in contact with the outer surface of the main body.
